(19) United States
(12) Patent Application Publication
(10) Pub. No.: US 2002/0095870 A1
(43) Pub. Date: Jul. 25, 2002

(54) Inner trimming member for a door of an automotive vehicle with a functional element mounted to the inner door trimming member

(76) Inventors: Jean-Pierre Praud, Auvers-sur-Oise (FR); Philippe Delire, Beaumont-sur-Sarthe (FR)

Correspondence Address: ROTHWELL, FIGG, ERNST & MANBECK, P.C., 1425 K STREET, N.W., SUITE 800, WASHINGTON, DC, 20005, US

(21) Appl. No.: 10/112,956

(22) Filed: Apr. 2, 2002

Related U.S. Application Data
(62) Division of application No. 09/520,769, filed on Mar. 7, 2000.

(30) Foreign Application Priority Data
Mar. 11, 1999 (FR) 99 03025

(51) Int. Cl. B60J 5/00

(52) U.S. Cl. 49/502; 296/146.7

(57) ABSTRACT

A vehicle door trimming member has a rigid carrier member that supports a rail. The rail is part of a window guide, for guiding a window when it is being rolled up or down. The rail is in two parts, with a latch connector for the door latch connected to the two parts. The door latch has two positions, a first preassembly position and a second operating position.

### CROSS-REFERENCE TO RELATED APPLICATIONS

This application is a Divisional of co-pending application Ser. No. 09/520,769.

### BACKGROUND OF THE INVENTION

1. Field of the Invention

The invention relates to the field of manufacturing cars, and especially, doors of cars and the inner trimming or lining thereof.

2. Description of the Related Art

Typically, the car doors as already known comprise an external double-walled panel, often made of steel, and an inner trimming generally having a decorative covering.

Functional elements adapted for operating the door are typically interposed (at least partly) between the external double-walled panel and the inner trimming thereof.

Such functional elements generally comprise window winder means, for lowering or elevating the window pane of the door, a latch (more precisely the part of the latch disposed on the door, a complementary part being disposed on the vehicle body, for maintaining the door in a closed position), an internal and an external handle both having an operating rod system. Possibly, a loud-speaker and other different elements (electric connectors, wiring . . . ) are also provided.

EP-A-286 923 discloses an inner trimming for the door of an automotive vehicle comprising:

a rigid carrier member,

at least one window guide member, for guiding the window pane when moving up or down, the window guide member comprising at least one rail along which the window pane is sliding, the rail being supported by the rigid carrier member, and

at least one functional element adapted for operating the car door and comprising at least one of a window winder, a door latch (also called door lock) together with its operating rods, and the inner handle of the door and the operating rods thereof.

However, a problem still occurs for obtaining an efficient connection of the window guide member to the inner trimming of the door (the zone where such a window winder member is to be disposed is narrow, especially for the rear doors of the vehicle).

### SUMMARY OF THE INVENTION

According to an important feature of the invention (and especially if the window guide comprises only one rail having one or a series of axial elements), the rail is connected to at least one of the above-mentioned functional elements, such as especially an element of the door latch, said element being itself connected to the inner trimming of the door.

Such a solution improves the integration of the window guide element to the inner trimming panel.

Especially, the window guide element can be connected to a plastic box typically called latch connector or latch housing.

For improving the above-mentioned integration, another feature of the invention relates to the connection between the window guide element and the carrier member: the window guide element is preferably movably fixed to the carrier member, so that it is movable between a first premounting position and a second operating position (in which the window guide element is ready to be operated).

Preferably, for improving the mechanical strength of the inner trimming, the rigid carrier member consists in a panel preferably extending over at least a main portion of the surface of the trimming and different functional elements of the door (window winder, latch, inner handle . . . ) are advantageously connected to the carrier member.

Thus, the window guide element can have a low mechanical resistance and can be made of a plastic material. The window guide element could even be integrated to a carrier member (viz. made in one piece therewith).

According to another important feature, the window rail(s) provided on the inner trimming of the door is (are) advantageously exclusively connected to said inner trimming, whereas at least some of the other functional elements, as above-mentioned, are connected to the trimming panel and to the external metallic wall of the door (door carcase), either by first fixation means providing the connection between the inner trimming and the external, double-walled door carcase, or by second fixation means, different from the first ones.

According to another feature of the invention, the window winder and/or the door latch is (are) fixed to the door carcase in its (their) second operating position, after having moved from its (their) first position to its (their) second position.

Furthermore, the carrier member will preferably have an outer decorative, shaped-face adapted to be visible from the passenger compartment of the vehicle, said outer shaped-face being possibly covered by a decorative layer, the carrier member further having an inner hidden face for fixing thereto the above-mentioned functional elements and the window guide rail.

### BRIEF DESCRIPTION OF THE FIGURES

Below is a detailed description referring to drawings in which:

FIG. 1 is a diagrammatic, perspective view of an inner trimming (or lining) for a right front door, shown from its hidden inner face,

FIG. 2 is a perspective view, partially exploded, of a front right door and the trimming of FIG. 1 showing its outer decorative face,

FIG. 3 shows in section, along III-III, the guide rail of FIG. 1 for guiding the window pane along the door trimming,

FIG. 4 is a diagrammatic front view, from the inner side, of a rear, right door having an inner trimming notably integrating a window guide rail having two parts,

FIG. 5 corresponds to the section V-V of FIG. 4,

FIG. 6 corresponds to the section VI-VI of FIG. 4,

FIG. 7 is a perspective view from the back (arrow VII of FIG. 9) of a latch element, and a latch connector fixed, according to the invention, to a window guide rail adapted for being disposed on a rear back door,

FIG. 8 is a vertical section along the line VIII-VIII of FIG. 9,

FIG. 9 is an horizontal section along the line IX-IX of FIG. 7 showing complementary elements of the door,

FIG. 10 is an alternative embodiment shown along the same section as the one of FIG. 8, and

FIG. 11 is the same alternative embodiment as in FIG. 10, along the same section as the one of FIG. 9.

### DETAILED DESCRIPTION OF THE INVENTION

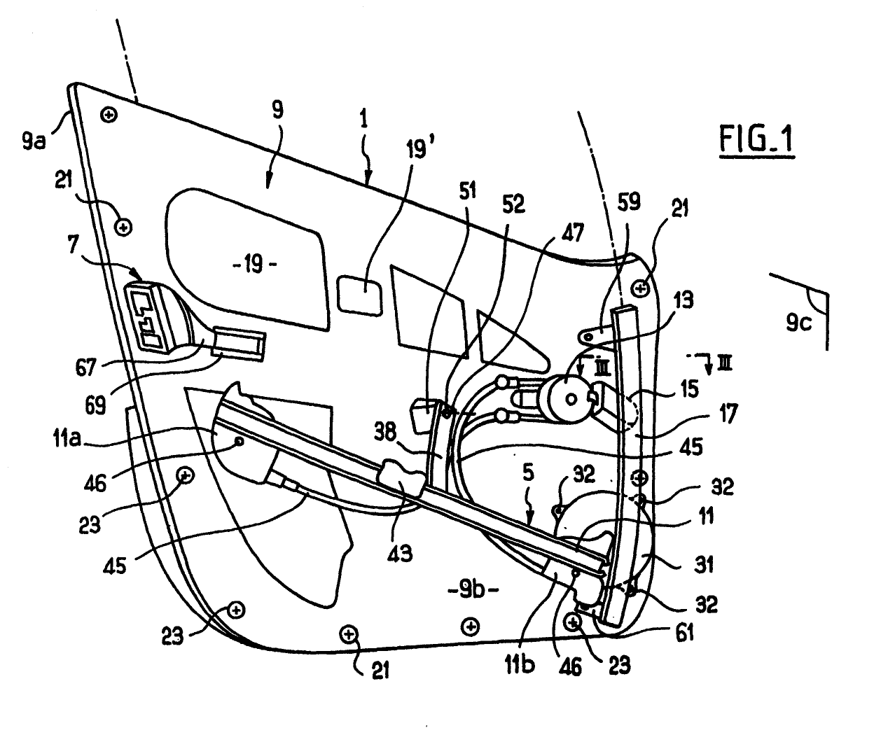

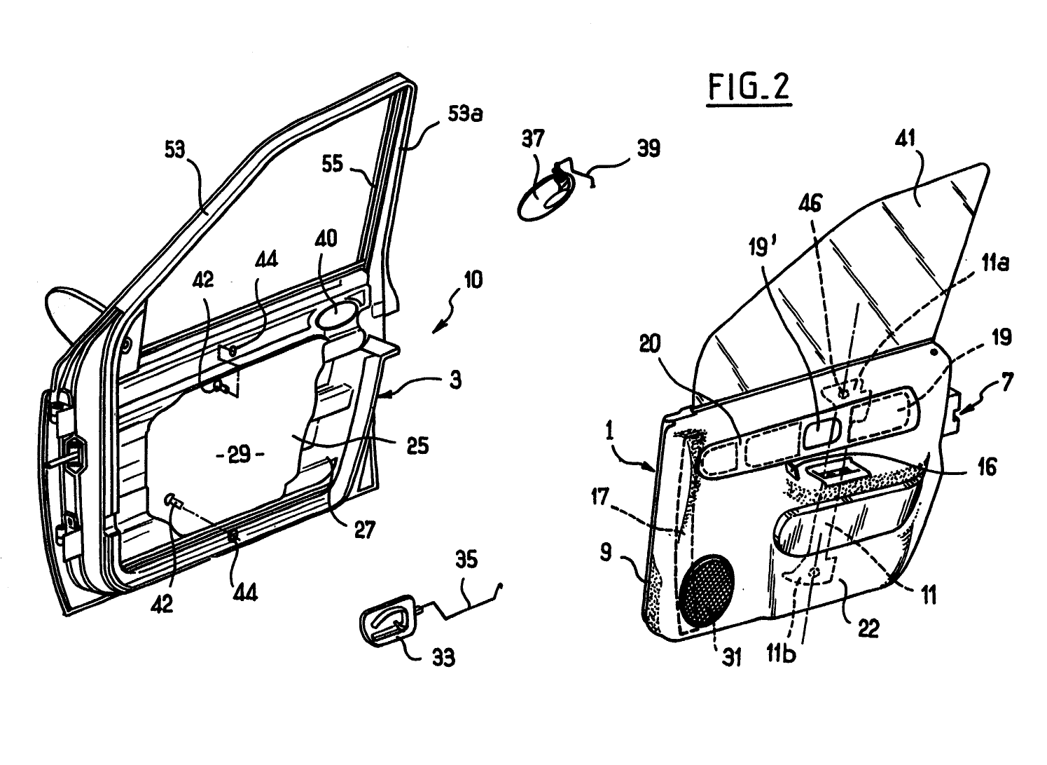

In FIG. 1 is illustrated in outline an inner lining (or trimming) 1 of a door, fitted for being, for example, assembled to the outer panel (or door carcase) marked 3 on FIG. 2 (typically made of steel), so as to constitute a door 10 with this panel as well as with different mechanical and/or electric or electronic functional elements, such as a mechanism of window winder referenced as a whole 5 and a lock (also called latch ) referenced as a whole 7 with respect to the part linked to the door (as opposed to the part of the lock linked to the structure of the vehicle and with which the part 7 must cooperate for maintaining the door in a closed position).

The lining of the door shown in FIG. 1 comprises a main carrier (or bearing panel 9) in plastic which is used as a bearer or a support (at least temporarily) of at least some of the functional elements of the door, such as the part 7 of the lock supported by the door, or the rail (or groove) of the pane guide 17, or the rail of window winder 11 with its control system 13 having an electric motor 15 and an outer control knob 16 (FIG. 2).

In the present example, a right front door is concerned.

The carrier panel 9 is, in the present case, in rigid plastic, such as polypropylene.

This carrier panel takes up the greater part of the surface of the lining 1 and shows, on the outside, a shape with distinct reliefs adapted to be visible from the passenger compartment (see FIG. 2).

In its upper third part, the carrier panel 9 shows also a long-shaped cutting defining an aperture 19 (in the present case, in three parts), on the passenger compartment side, giving access to the inside of the door, once the door is assembled, from the outer visible side of the panel, referenced 9a (as opposed to the “hidden” inner side of the panel referenced 9b). Another aperture 19′ is provided for the fifting of the inner handle of the door.

The aperture 19 can, in particular, be covered with an inserted trim panel (called “medallion”) 20, which is typically fastened on the panel 9 for example with staples (FIG. 2), so as to be detachable of it.

In addition to such a medallion, the lining 1 of the door can also comprise an ornamental covering sheet 22 covering the carrier panel, wholly or partly, on the passenger compartment side. This decorative sheet can be made, in particular, of a plastic film lined with a foam undercoat; it can also be made of leather, for example, such a covering being, for example, glued or fastened in any other appropriate way (for example molded), on the carrier panel 9.

As disclosed on FIGS. 1 and 2, the inner lining 1 can be fastened on the outer panel 3 of the door, through peripheral openings 21, in which staples 23 are inserted. The outer panel of the door 3 can typically look like a box and comprise an outer wall 25 locally lined with an inner wall 27, such as illustrated by the FIG. 2, where, besides, it can be seen that the inner wall 27 shows a very large central aperture 29.

The outer panel 3 of the door might be made of metal, or even in plastic or in composite material, among others.

Other shapes of inner carrier might fit, such as a flatter carrier which would not be involved in the shape of the covering lining, this part being held then by an inserted trim panel. The carrier panel might also extend on a part only of the height of the inner lining of door, or even it might look like a frame with some transverse cross members (solutions not illustrated).

Although the carrier panel is very advantageously in plastic, it might be metallic (steel) or even in a composite material (made from wood, glass fibre, . . . ).

In FIG. 1, as an additional functional element of the door, the presence of a loud-speaker 31 (screwed on the panel 9 at the point 32) can be noted it is also illustrated in FIG. 2 which, in addition, discloses that the inner lining 1 of door is supplied with an inner handle 33 linked up to the lock element 7 by a system of rods 35 and is adapted for being set out in the aperture 19′.

The outer panel 3 of the door shows an outer handle 37 which is linked up to the lock element 7 by a system of rods 39. The handle 37 is fitting in an aperture 40 of the panel 3.

In FIGS. 1 and 2, the inner lining 1 comprises a pane 41 which fits into the rail 17, when it slides inside the lining 1. The pane is under control of the sliding block 43 of the window winder rail 11 driven by the motor 13 via the wiring 45.

In FIG. 2, the rail of window winder 11 (which is drawn like in transparency with shadow lines) is illustrated in its running position (substantially vertical, whereas in FIG. 1, this very rail is illustrated in its “transport” position (substantially horizontal), the transition from the first “transport position” to the second running position, is carried out by pivoting the rail round the axis 47 (which is an horizontal axis perpendicular to the general plane 9c of the carrier panel 9). Through said axis, the transverse arm 38 of the rail 11 is linked to and turns round the pillar 51 which fastens the rail with the carrier panel 9. This pillar stands perpendicular to the inner surface of the panel 9b in which it is inserted and from which it projects. A screw represented in outline under reference 52, holds the arm 38 with the pillar 51.

In its running (or operating) position, the rail 11 of FIG. 2, is adapted so that its ends, respectively upper one 11a, and lower one 11b, stand behind the inner wall 27 of the outer panel 3 and are fastened on it by inserted fastening means 42 (such as screws) fitting, through the aperture 29 of the outer panel 3, into openings working together (44, 46) respectively made through the wall 27 and the end heads 11a, 11b of the rail 11.

The screws 42 (or any other equivalent fastening means, such as staples) might be chosen for fastening the inner lining 1 with the outer panel 3, and conversely, the staples might be chosen for fastening the inner lining 1 to the outer panel 3.

Above its case part 25-27, the panel of door 3 comprises a pane frame 53 forming one block with the outer panel 10. Along its back post 53a substantially vertical, the frame 53 includes a slide of pane guide 55 typically “U-shaped”. In addition, a pane joint is, in general, provided at this place (not illustrated).

Thus, when the pane 41 is pulled down, a first transfer of guiding is carried out from the back part of the door (slide 55) to the front part of the door, together with a second transfer between the outer panel 10 (slide 55) and the inner lining 1 (slide 17).

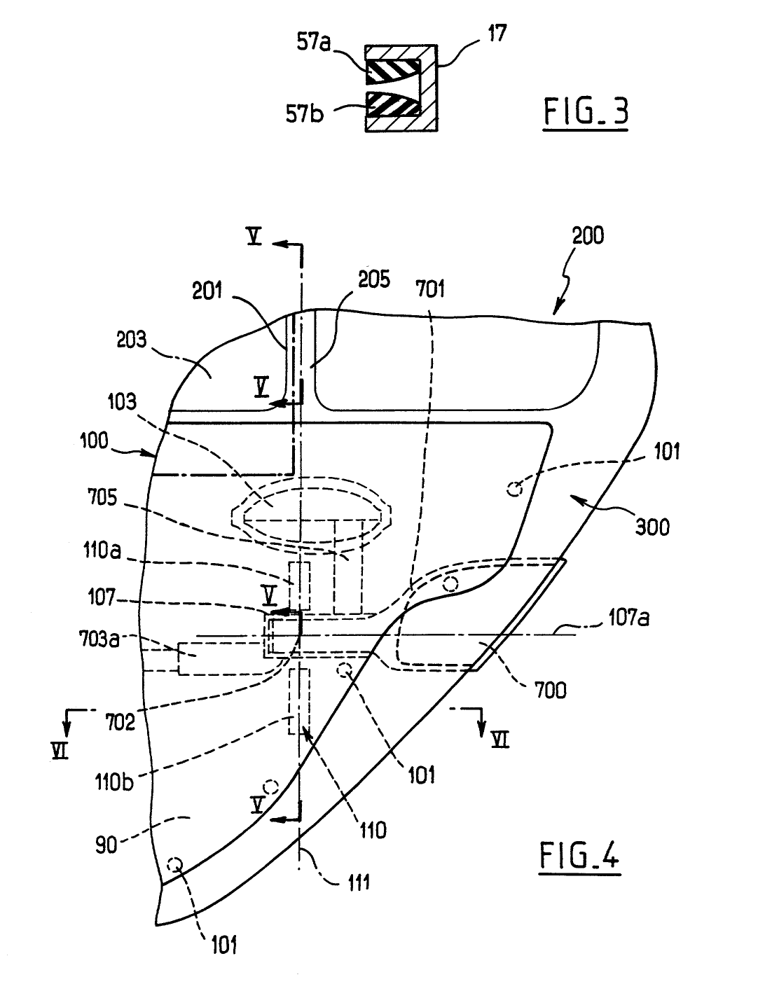

Like the rail 55, the rail 17 shows a “U-shaped” section, as illustrated in FIG. 3, with an inner joint having two lips 57a, 57b.

In the present case, the rail 17 is like a long beading arranged substantially vertically and spaced apart from the inner lining surface 9b, so as to, so as to supply the moving guiding of the pane, at about this lining.

The rail 17 is fastened (for example screwed) to the inner surface 9b of the carrier panel 9 through an upper flap and a lower flap, respectively referenced 59 and 61 (FIG. 1).

The whole pane guide (17, 59, 61) may, in particular, be made of plastics (polypropylene, notably).

It might be molded with the carrier panel 9 in one piece.

On the FIG. 4, a part of a right back door is shown.

Such as illustrated, the inner lining 100 is shown assembled with the outer panel of door 300. Hidden staples 101 stand for the fastening between these two parts.

The outline of the illustrated part of the inner lining 100 is reinforced so as to be more visible.

The reference 103 shows, in a simplified manner, the location of the outer door handle fastened to the outer panel 300 and linked up, through the operating set of rods, to the latch part 700 supported by the door, which as a whole is referenced 200.

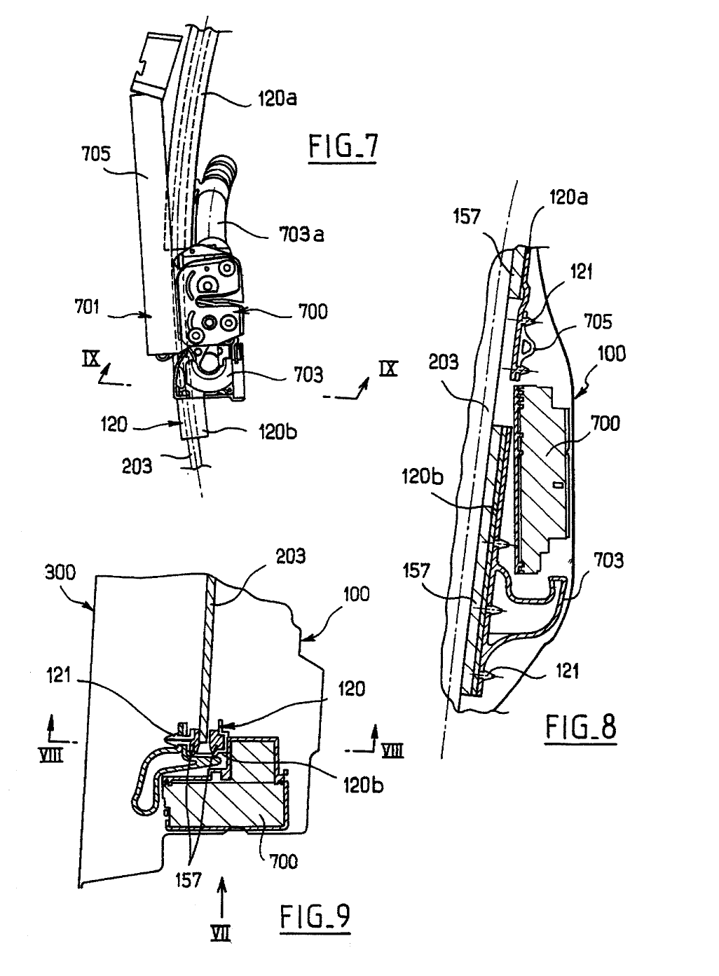

The latch part 700, represented in FIGS. 7 to 11, is standard (metallic structure), except the fact that its plastic connection box, typically called “latch connector”, referenced as a whole 701, includes a slide 702 which can extend axially on one side, like a prominent arm (see the example illustrated in FIG. 4).

The slide 702 fits horizontally into a sliding rail 107, molded in one piece with the inner surface of the carrier panel 90 which, like the carrier panel 9 of the FIG. 1, constitutes a base structure for the lining 100.

In the present case, the rail 107 is in rigid plastic.

The partial view represented in FIG. 5 shows that the rail 107 projects towards the outer panel 300.

As another option, this rail might be metallic and inserted (for example screwed) on the inner side of the carrier panel.

Preferably, the rail 107 will have a double rim 107a for retaining the slide 702, once fitted into the rail.

In this way, car equipments constructor will be able to preassemble the locking part 700 with the trim lining that he will deliver to car manufacturer.

In this preassembled state, the slide 703 may be in back thrust position, at the end of the rail, and is laterally maintained by the rim 107a, a tie being alike to avoid, moreover, its sliding along the rail. Once delivered to the car manufacturer, at the time of the assembly between the trim lining and the sheet metal of the door, the manufacturer will be in a position to slide the lock along its horizontal axis 107a (after removal of the tie) for bringing it into its fastening position on the door carcase, at the predefined place intended to. The locking element 700 will be then fastened (in general screwed) on the door carcase 300.

The locking part supported on the door, will be thus, in its running state, linked both to the outer panel of door and to the inner trim lining, after its guided moving from its preassembled position (in which it is only linked to the inner lining 100) to its running position on the outer panel.

It must be noted that this system may be applied to the front door of FIGS. 1 and 2.

Besides, on these figures, it can be seen that the latch 7 is set up on the inner trim lining 1. On the FIG. 1, in addition, the lock part 7 can be seen with its slide 67 of lock connector fitted into a rail 69 so as to be able to slide. Further, the locking member 7 is molded in one piece with the inner surface 9b of the carrier panel 9.

FIGS. 4 to 11 must be carefully studied for noting the structural overlap provided between the lock element 700, as a whole, and the pane-guide element linked to the inner lining 100 and referenced as a whole 110.

In the example, this pane-guide comprises two coaxial sections: 110a (upper), 110b (lower) respectively located above and under the rail 107.

In FIG. 5, only the lower section 100b is shown.

The two pane-guide sections 110 are located in the axial alignment (in the present case, along the substantially vertical axis 111) of the upper back guiding rail 201 of the sliding pane 203 (on this FIG. 4, a part of the outline of the pane is delimited by combined lines; the pane is in upper position).

The rail 201 is a part of the vertical post of the pane frame, which itself is a part of the outer wall of door 300.

In FIG. 5, are shown a part of the post (or jamb) 205 with the rail of the upper bay 201, and a part of the pane 203.

In this position, i.e. slid further down, compared to the one of FIG. 4, the pane 203 works together with the pane-guide 110 linked to the inner lining of the door 100. And it can be well seen that, when it is slid down between the door case and the inner trim 100, this pane is the object of an additional effective guiding.

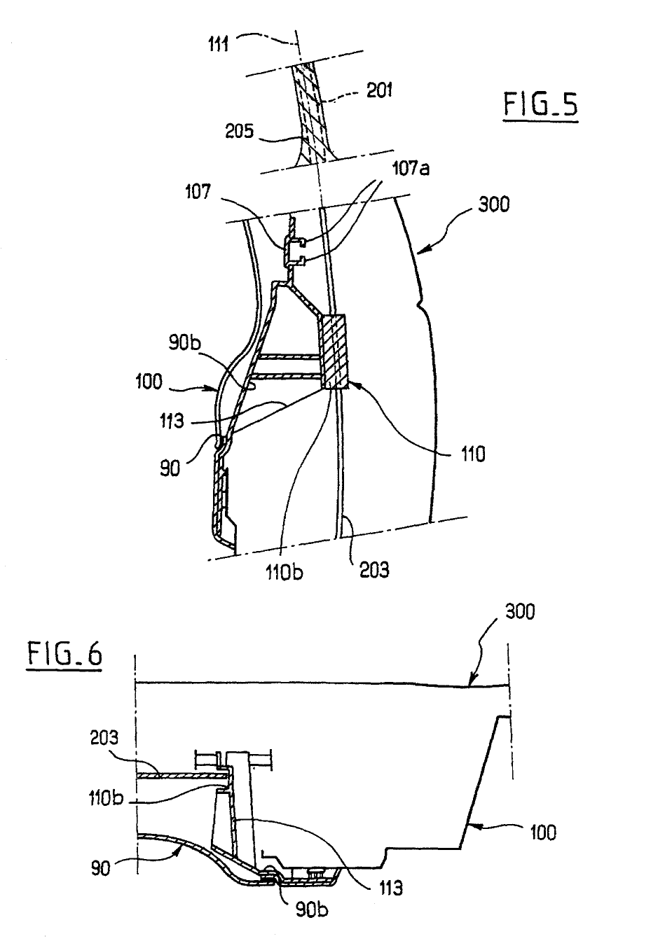

The pane-guide 110, and in particular its lower section 110b, only illustrated here, is constituted with a rail in plastics, which is molded in one piece with the inner surface 90b of the carrier panel 90 (see also FIG. 6) from which it projects and to which it is linked by a blade 113.

Thus, this set 110/113 is, in a way, like a rib which, as a matter of fact, strengthens the panel 90 and therefore the inner lining 100.

In FIGS. 7 to 11 which are related to a back left door, the pane-guide, linked to the inner lining of door, and referenced as a whole 110, is connected to the latch connector 701.

The latch connector 701 comprises a lower connector (typically called “latch connector lower”) and a upper connector 705 (typically called “latch connector upper”).

These upper and lower connectors provide control and operating connection round about the lock, between this lock and the inner and outer handles of the door.

Thus, the upper connector 705 contains the operating set of rods permitting the operation of the lock element 700 by the working of the handle 103 (FIG. 4).

The lower connector 703 contains, in particular, an operating tubulure 703a substantially horizontal, which projects towards the front of the door and in which runs the “operating set of rods” (not illustrated).

This set 700, 703, 705 is standard and will not be described further, especially since it does not constitute an element of the invention, except with regard the fact that the pane-guide element 110 is linked to its structure.

With regard to this point, it will be perhaps easier to see on the FIGS. 7 and 8 that, in the example such as illustrated, the pane-guide element 110 is interrupted where the lock element 700 is, and in consequence shows two parts, which are coaxial though they stand apart below one another, 110a, 110b.

Each of these parts 110a, 110b, is linked (in the present case, fastened by inserted staples 121) to the lock connectors, both lower, 703 and upper, 705 ones.

Of course, each of these parts 110a, 110b, is like a slide with a substantially “U-shaped” section, including a two lipped-joint (such as referenced 157) between which the pane 203 may slide, guided in its sliding motion up and down, between the panels 100 and 300. It must be noted that, even if the pane-guide 110 is structurally connected, in the present case, by the lower latch connector 703 and upper latch connector 705, the mechanical connection with the carrier panel 90 is carried out at least by the slide 702 an additional fastening is obtained when the lock 700 is fastened on the outer panel of door 300.

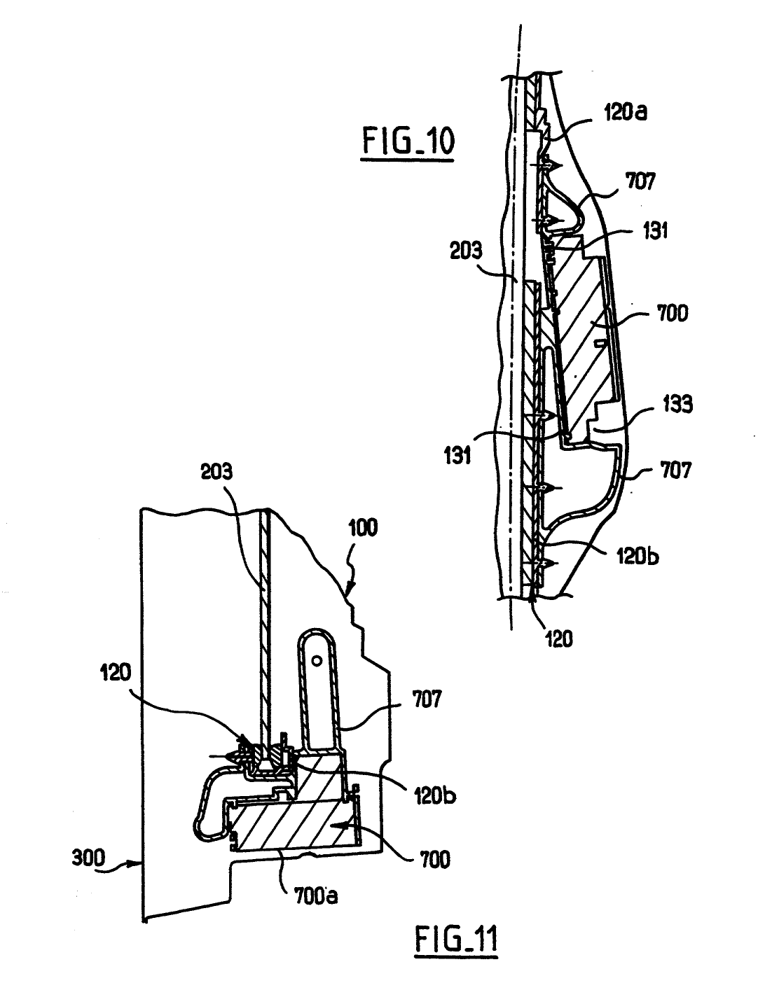

In the alternative shown by FIGS. 10 and 11 (which is also related to a back left door), the latch connector, referenced 707, is in one piece, so that the upper and lower connectors (“latch connector upper” and “latch connector lower”) are assembled in one piece and made of plastic.

The metallic lock element 700, which is the same as the one previously described in relation to FIGS. 4,7,8, is elastically inserted, via blades 131, and blocked up inside the recess defined by the connector 707, at a location referenced 133 on FIG. 10.

In the box 707, which is widely open on the back face 700a of the element 700, for permitting to the locking element to operate, the latter is efficiently maintained in a predetermined position, before being fastened on the metallic double-wall 300, as previously mentioned.

In FIG. 11, which shows the connector 707 at the same place of the drawing than the lower latch connector 703 and upper latch connector 705 illustrated in FIG. 9, it can be noted that the pane-guide 110 is identical to the one of the FIGS. 8 and 9, with its two parts 110a, 110b also fastened by a stapling above and below the latch element 700, which requires this interruption in the structural continuity of the pane-guide.

What is claimed is:

1. An inner door trimming member adapted for lining a door of a vehicle, the inner door trimming member comprising:
a rigid carrier member,
at least one window guide member, for guiding a window pane when moving up or down, the window guide member comprising at least one rail, said rail being supported by the rigid carrier member, and
a functional element connected to the inner door trimming member;
wherein the rail is connected to the rigid carrier member through said functional element.

2. The door trimming member according to claim 1 wherein:
said functional element comprises a door latch;
said door latch comprises a door latch connector connected to the door trimming member.

3. The door trimming member according to claim 1, wherein the functional element is movably connected to the rigid carrier member, said functional element having a first premounting position and a second operating position.

4. The door trimming member according to claim 1, wherein the rail of the window guide member comprises a plurality of parts, the parts being arranged along an axis.

5. The door trimming member according to claim 4, wherein said parts of the rail include an upper part and a lower part respectively connected to an upper latch connector and a lower latch connector.

6. The door trimming member according to claim 1, wherein:
said functional element comprises a door latch;
the rail of the window guide member comprises an upper portion and a lower portion spaced one from another, the upper portion and the lower portion being arranged along an axis, for moving the window pane, the upper portion extending above the door latch, and the lower portion extending below the door latch.

7. The door trimming member according to claim 3, further comprising:
a sliding guide connected to the rigid carrier member; and wherein:
the door latch connector is slidably connected to the sliding guide.

8. A door for an automotive vehicle, the door comprising:
an external door carcase, having an inner panel, the inner panel having an opening therethrough, and
an inner door trimming member adapted for lining said external door carcase, the inner door trimming member being adapted to be disposed in front of the opening of the inner panel, and comprising:
a rigid carrier member,
at least one window guide member, for guiding the window pane when moving up or down, the window guide member comprising at least one rail along which the window pane slides, the rail being supported by the rigid carrier member, and
at least one functional element adapted for operating the vehicle door, wherein:
the rail is connected to said rigid carrier member through said functional element, and wherein
said functional element is connected to both the inner trimming member and the external door carcase.

9. The door according to claim 8, wherein the functional element is connected, in a movable manner, to the rigid carrier member for being movable on the innertrimming member, between a first premounting position and a second operating position, and is connected to the external door carcase in the second operating position.

10. The door according to claim 8, wherein the rigid carrier member has:
a visible face having relief;
said face being visible from the passenger compartment of the vehicle;
said rigid carrier member being covered with a decorative layer, and
a hidden face for fixing the functional elements and the rail of the window guide thereto.

11. The door according to claim 8, wherein the door latch is movably connected to the rigid carrier member, said functional element having a first premounting position and a second operating position, and wherein said functional element is connected to the external door carcase in the second operating position.

12. The door trimming member according to claim 1 wherein:
said functional element comprises a window winder.

13. The door trimming member according to claim 1 wherein:
said functional element comprises:
a door latch;
first operating rods adapted for operating the door latch;
an inner handle; and
second operating rods adapted for operating the inner handle.

14. The door according to claim 8, wherein said functional element comprises a window winder.

15. The door according to claim 8, wherein said functional element comprises:
a door latch;
first operating rods adapted for operating the door latch;
an inner handle; and
second operating rods adapted for operating the inner handle.
